(19) United States
(12) Patent Application Publication
(10) Pub. No.: US 2006/0176563 A1
(43) Pub. Date: Aug. 10, 2006

(54) Apparatus for converting light beams

(76) Inventor: Yixuan Xiao, Beijing (CN)

Correspondence Address: Dingrong Qian, 5026 Hutton Street, Fremont, CA, 94538, US

(21) Appl. No.: 10/515,680

(22) PCT Filed: May 27, 2003
(86) PCT No.: PCT/CN03/00398

§ 371 Date: Jun. 27, 2005

(30) Foreign Application Priority Data
Sep. 3, 2002 (CN) 02253490.3

(51) Int. Cl. G02B 27/10

(52) U.S. Cl. 359/618

(57) ABSTRACT

Optical devices for reforming optical beam and, hence, changing its size-divergence products along two directions perpendicular to beam propagating direction is disclosed. In one approach 90° roof reflector array is employed while in another approach 45° roof reflector array is employed. A simple reflection on the roof reflector array reforms optical beam and enables the adjustment of size-divergence product and, hence, provides the possibility of achieving symmetric beam. The other applications of the devices are beam switch beam equalizer. The devices are of great significance for diode laser and diode laser array.

### TECHNICAL FIELD

This invention relates generally to optical systems and, more particularly, to a beam reforming apparatus for light beam or light beam array to achieve symmetric size-divergence product along two orthogonal directions perpendicular to propagating direction and to switch, equalize light power between two directions orthogonal to each other.

### BACKGROUND

It is well-known that due to optical invariance, the size-divergence product (SDP), or Lagrange invariant, of a light beam is constant throughout an optical system.

The large difference in beam quality of edge emitting diode laser along lateral direction, the direction parallel to its PN junction or quantum well plane, and transverse directions, the direction perpendicular to PN junction or quantum well plane, results in difficulty when it is desired to focus the diode beam into a spot with symmetric size and divergence or to coupled the diode beam into a fiber. For a typical diode laser emitter, the lateral dimension is dₛ=159 μm, the transverse dimension is d_{f}=1 μm and the divergent angle along lateral direction (slow axis) is θₛ=12°, the divergent angle along transverse direction (fast axis) is θ_{f}=40°. The size divergence product along lateral direction is SDPs=dₛ sin (θₛ/2)=16.62, and size-divergence product along transverse direction is SDP_{f}=d_{f} sin (θ_{f}/2)=0.34. The ratio of size-divergence product along the two directions is R=SDPₛ/SDP_{f}=dₛ sin (θₛ/2)/d_{f} sin (θ_{f}/2)=17.36/0.34=49. The great R indicates the asymmetric property of the light beam and no optical system can focus the beam into a symmetric spot where both its size and divergence angle, or NA, along slow axis and fast axis are equal to each other. The R can be even greater when a wider emitter or a whole diode laser bar which consists of a linear array of emitters along their slow axis is considered.

There are a number of beam shaping techniques to produce round beam spot from line-like emission of edge emitting diode laser at certain distance. However, the inherent SDP difference is still an obstacle for some of its applications.

To overcome the difficulty cause by the inherent asymmetric property of edge emitting diode laser, techniques have been developed which successfully reformed the laser beam, such as U.S. Pat. No. 5,168,401, No. 5,592,333, No. 6,240,116 and No. 4,763,975.

This invention adds two more approaches in the beam reforming efforts to reforming line-like beam including the beam from edge emitting diode laser and beams from edge emitting diode laser array by a simple reflection on a roof reflector array. The devices are wavelength independent. In addition, the invention provides other applications, for example, switch and beam equalizer.

### SUMMARY OF THE INVENTION

This invention is to manipulate light beam or beam array to change their SDPs along lateral and transverse directions, or to switch the position and propagation direction of light beam or beam array.

Following approach is employed for this purpose.

A beam manipulation device which consists of a roof reflector or a roof reflector array with following features.

The roof reflector consists of two mirror, their intersect line is ridge of the roof reflector; the dihedral angle is the integer times of 45°, but not greater than 90°.

All of the roof reflectors are aligned along the lateral direction of the incoming light beam or beam array with their opening towards the incoming beam or beam array and their ridges parallel to the transverse direction of the beam or beam array; all of the roof reflectors or roof reflector array are integrated on a plate which can rotate arbitrarily;

In one embodiment of the invention, the dihedral angle is 45°.

In other embodiment of the invention, the dihedral angle is 90° and the ridges of the roof reflectors or roof reflector array are rotated around the propagating direction of the light beam or beam array by 45°.

For beam array, the opening of each roof reflector is equal to or larger than the width of each beam at the roof reflector. For single beam, the roof reflector opening can be smaller than, equal to or larger than the beam width at reflector.

The device described above can either reform a light beam like the beam or beam array from edge emitting diode laser into a new beam array with equal SDP along lateral and transverse directions or redirect the light beam or beam array into two directions orthogonal to each other with adjustable strength.

### DESCRIPTION OF DRAWINGS

FIG. 1 presents a 90° roof reflector consisting of two mirrors perpendicular to each other, the intersection line of the two mirrors is the ridge.

FIG. 2 presents a tilt about Z-axis by −45° on the 90° roof reflector in FIG. 1, the tilted 90° roof reflector is reflector 5.

FIG. 3 presents further tilting on the 90° roof reflector 5 presented in FIG. 2: a tilt about X-axis by −45°. The tilted roof reflector is 90° roof reflector 8.

FIG. 4 presents one of the embodiments of this invention to tailor beam size-divergence product (SDP) at its lateral and transverse directions.

FIG. 5 presents another embodiment of this invention for a wide emitter. 90° roof reflector array 24 is built and placed in the same way as array 17 in FIG. 4 except that there is no flat strip between adjacent reflectors.

FIG. 6 presents another roof reflector which is a 45° roof reflector consisting of two mirrors 25 and 26 with 45° dihedral angle.

FIG. 7 presents what is going to happen when a thin beam 28 comes to 45° roof reflector.

FIG. 8 presents a beam 31 originated in X-Z plane from the negative side of X-axis propagating upward to the 45° roof reflector with directional cosine (0, −1/\sqrt{2}, 1/\sqrt{2}).

FIG. 9 presents a thin beam 33 originated in X-Z plane from the positive side of X-axis propagating upward to the 45° roof reflector with directional cosine is (0, −1/\sqrt{2}, 1/\sqrt{2}).

FIG. 10 presents an embodiment of this invention where beams propagate upward to a 45° roof reflector array and get reflected so that beam configuration, as well as SDP along lateral and transverse directions, is changed.

FIG. 11 presents an embodiment of this invention where a group of rays originated from X-Z plane with different x positions are coming upward to a 45° roof reflector and get reflected so that the directions and positions of the reflected rays are related to their original positions.

### DETAILED DESCRIPTION OF THE INVENTION

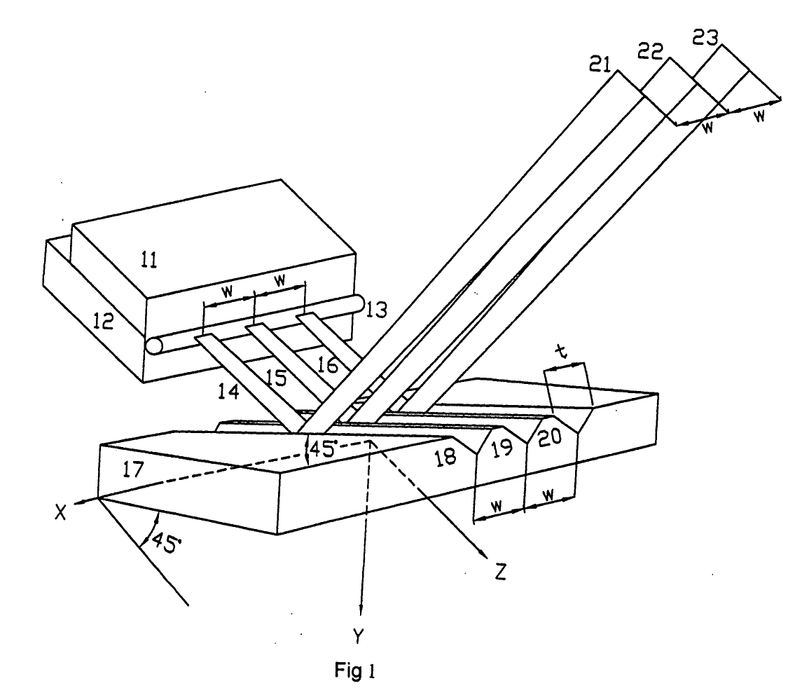

The optical principle of this invention are depicted in FIG. 1 through FIG. 3 and FIG. 6 through FIG. 9. The roof reflector consists of two mirrors, their intersect line is the ridge, their dihedral angle is 90° or 45° called 90° roof reflector or 45° roof reflector, respectively.

In FIG. 1, the ridge of the 90° reflector is placed on Y-axis and Y-Z plane is its planar bisector. Ray 1 at x=g in X-Z plane propagates parallel to Z-axis towards the roof reflector; it is reflected back in reverse direction and the reflected ray 2 will be at x=−g. If a thin beam 3 in X-Z plane, instead of ray 1, with its width from −g to g incidents on the roof reflector, the reflected beam 4 will be coming back in X-Z plane in reverse direction of beam 3. The beam orientation will be rotated about Z-axis by 180°, as the small circles near beam 3 and 4 indicated.

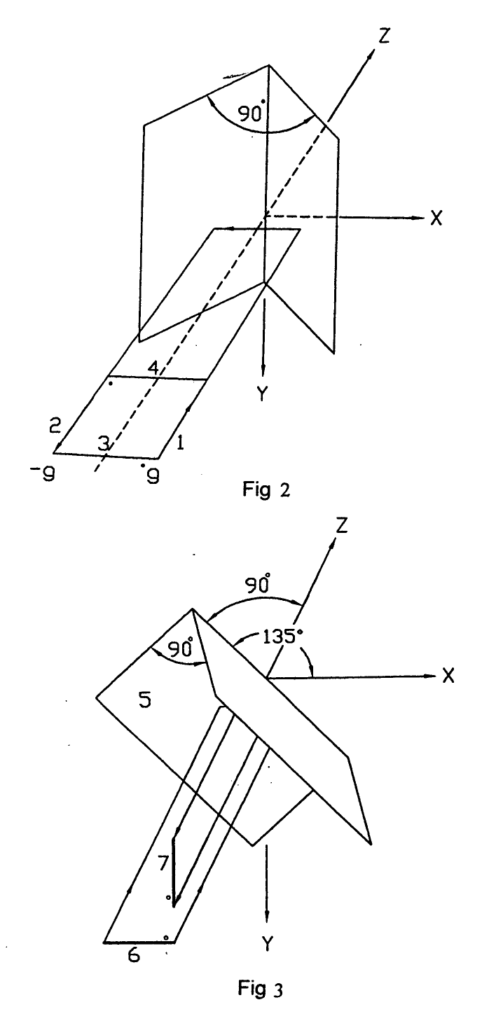

Then the 90° reflector is tilted about Z-axis by −45° becoming reflector 5 (FIG. 2). The thin light beam 6 in X-Z plane propagating to the reflector along Z-axis with its lateral direction being parallel to X-axis and transverse direction being parallel to Y-axis is reflected; the reflected beam 7 propagates along −Z-axis in Y-Z plane. However, due to the tilting on 90° roof reflector, the orientation of reflected beam 7 has been rotated about Z-axis by 90°, as the small circle besides beam 6 and beam 7 indicated.

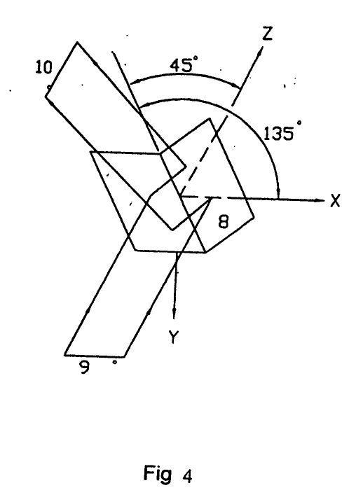

In order alter the propagate direction of the reflected beam 7, the 90° roof reflector is further tilted about X-axis by −45° becoming roof reflector 8 in FIG. 3, the lateral direction of incoming beam 9 is along X-axis. The reflected beam becomes 10. The reflected beam 10 comes out in Y-Z plane with directional cosine (−1/\sqrt{2}, −1/\sqrt{2}, 0), and its lateral direction is aligned with negative Z-axis, (the small circles near the two beams indicate beam orientation). In other words, two significant changes in the reflected light beam 10 have happened: beam propagating direction is changed from being parallel to Z-axis with directional cosine (0, 0, 1) to being perpendicular to Z-axis with directional cosine (−1/\sqrt{2}, −1/\sqrt{2}, 0) and beam orientation is changed from being perpendicular to Z-axis to being parallel to negative Z-axis. These changes caused by the 90° roof reflector 8 are important in its application.

One of the embodiments of this invention is a beam reforming device where 90° roof reflector is used (FIG. 4). A diode laser bar 11 is mounted on its substrate 12. On the bar, there are emitters distributed in a line along emitter lateral direction (X direction), their emission along emitter transverse direction (Y direction) is, for the purpose of clarity, collimated by micro lens 13 but their divergence along lateral direction is not collimated. The transversely collimated beams (14, 15, 16) are propagating along emitter longitudinal direction (Z direction) and come to plate 17 where an array of 90° roof reflectors (18, 19, 20) in the configuration described in FIG. 3 is placed. The reflector width t is equal or larger than beam width at reflector, and reflector period w is the same as the emitter period w on diode laser bar 11. The reflected beams will be propagating with directional cosine (−1/\sqrt{2}, −1/\sqrt{2}, 0) which is perpendicular to Z-axis. The beam configuration, thus, has been rearranged: light beams (14, 15, 16) lined along their lateral direction with period w turn into light beams (21, 22, 23) stacked along beam transverse direction with period w. This rearrangement provides possibility to tailor beam size-divergence product (SDP) along its lateral and transverse directions.

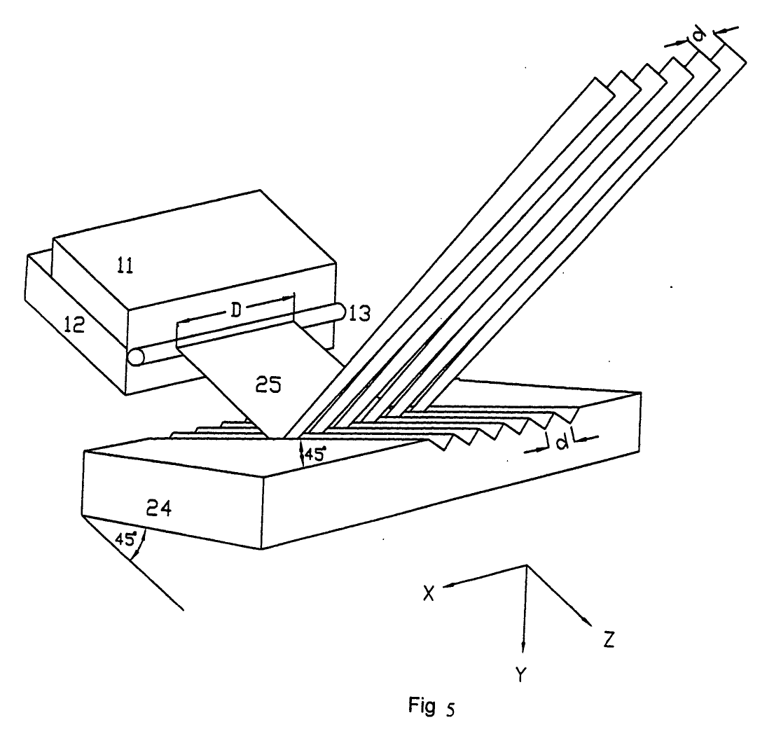

Another embodiment of this invention is for wide emitter (FIG. 5). 90° roof reflector array 24 of totally n reflectors is built and placed in the same way as array 17 in FIG. 4 except that there is no flat strip between adjacent reflectors. Beam 25 of width D from the wide emitter is reflected by 90° roof reflector array 24. After reflection, the wide beam D is chopped into n narrow beams stacked along beam lateral direction with period of d. where d=D/n and n should be integer.

As discussed in U.S. Pat. No. 5,168,401, the product of SDP ratio R for incoming beam times and SDP ratio R′ for reflected beam equals to n², i.e. RR′=n². Thus, by properly choosing n, beam SDP ratio R′ can be adjusted. If, for example, R′=1 is needed, then simply build said 90° roof reflector array 24 with n=\sqrt{R}. In our case, n=7 is a good design for R=49. Again, for the purpose of clarity, beam D is collimated along its transverse direction but not collimated along its lateral direction. In real case, beam collimating before 90° roof reflector array 24 is not necessary.

The array of 90° roof reflectors can be arbitrarily rotated around X-axis and the direction of reflected beam will be changing correspondingly, but the product of SDP ratio R for incoming beam times and SDP ratio R′ for reflected beam will never be changing.

A 45° roof reflector consisting of two mirrors 25 and 26 with 45° roof angle (FIG. 6). Ray 27 is parallel to its angular bisector Z-axis. When the ray comes to mirror 25, it is reflected to mirror 26. After being reflected from mirror 26, the ray will propagate in a direction parallel to X-axis. The dashed lines perpendicular to mirror 25 and 26 are their normal.

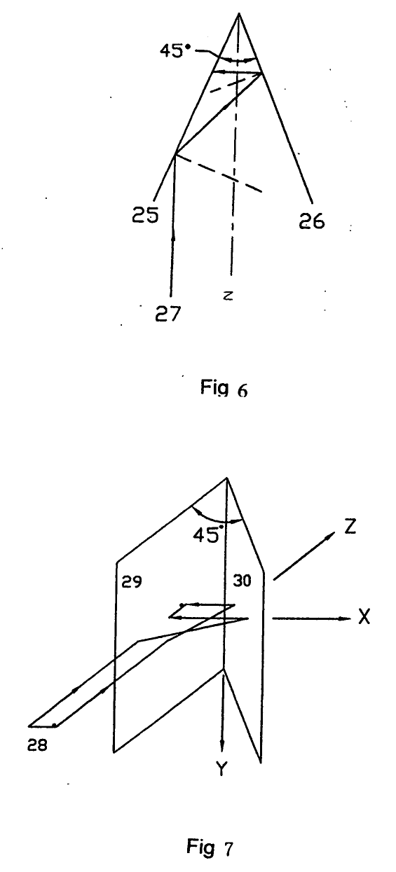

When a thin beam 28, instead of a ray 27, comes to the 45° roof reflector (FIG. 7), the beam will be reflected by mirror 29 first and then reflected by mirror 30. After the two reflections, the beam will propagate in parallel to X-axis, its lateral direction will be turned about Y-axis by −90° as what the small circle indicated.

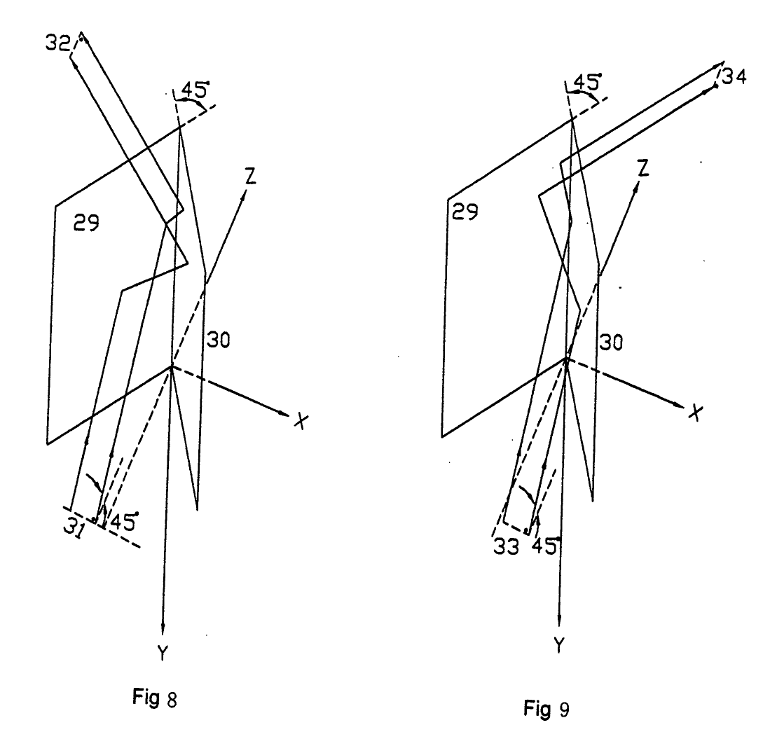

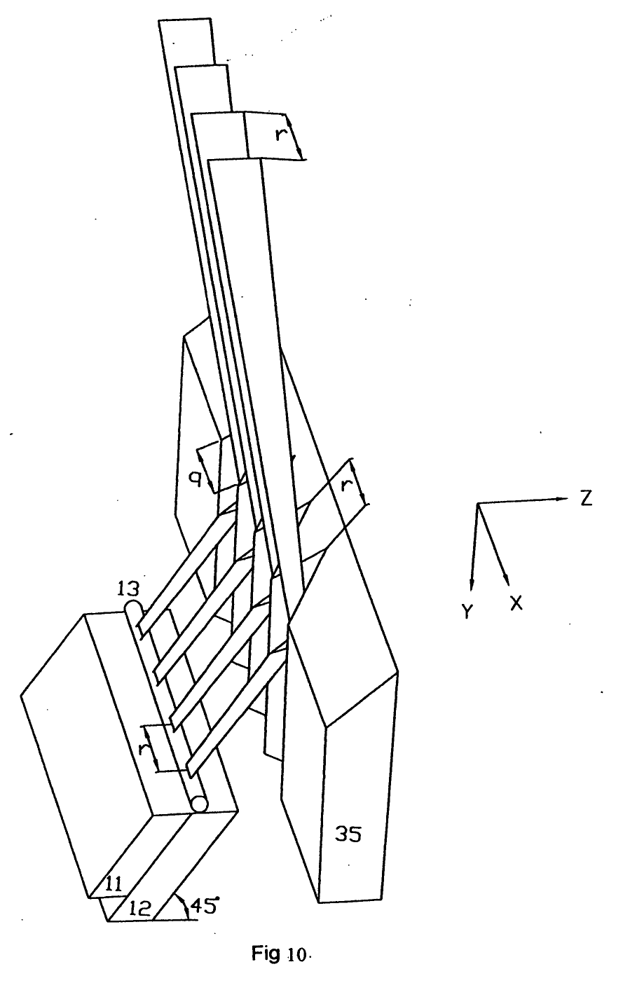

The 45° roof reflector configuration provides a number of applications. For example, if the light beam propagates towards 45° roof reflector upwardly with directional cosine (0, −1/\sqrt{2}, 1/\sqrt{2}) , as beam 31 in FIG. 8 does, the reflected beam 32 will propagate with directional cosine (−1/\sqrt{2}, −1/\sqrt{2}, 0) which is perpendicular to Z-axis. If the position of beam 31 in FIG. 8 is shifted from negative on X-axis to positive on X-axis, as beam 33 in FIG. 9 does, the reflected beam 34 is still perpendicular to Z-axis but the directional cosine becomes (1/\sqrt{2}, −1/\sqrt{2}, 0) which is orthogonal to beam 32 in FIG. 8.

An array of 45° roof reflectors can also be employed to reform a light beam array. In one of the embodiments of this invention (FIG. 10), beams from emitters on diode laser bar 11 are collimated by lens 13 and propagate upward to a 45° roof reflector array 35, the upward angle is 45° or other angle as long as the beams can be reflected out of the 45° roof reflector array 35. The period of 45° roof reflectors in the array 35 is r which is also the period of emitters on diode bar 11. The beam width at 45° roof reflector array 35 is less than half of the reflector width q, so that beams shine on only one of the two mirrors of a reflector. It is seen again that the incoming beams aligned along beam lateral direction with period r turn out to be stacked along transverse direction with period r after being reflected. This change, once again, provides a beam reforming approach to tailor SDP along lateral and transverse directions.

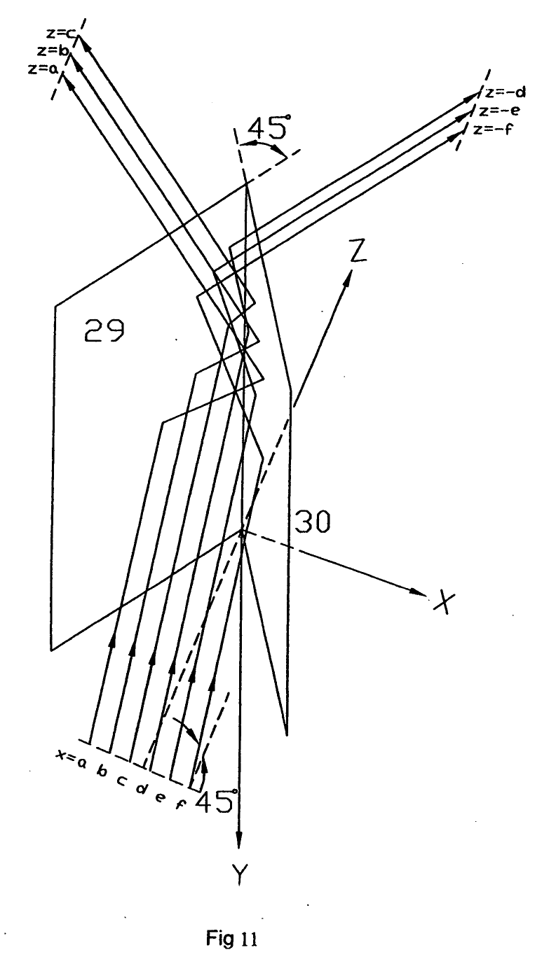

Another embodiment of this invention is beam equalizer (FIG. 11). Six rays, or beams, originated from X-Z plane with x=a, b, c d, e, f, respectively, are coming upward to a 45° roof reflector. Their upward angle is 45° or other angle as long as the beams can be reflected out of the 45° roof reflector array. Three of them originated from the negative side of X-axis, i.e. x=a, b, c, will be reflected and propagating with directional cosine (−1/\sqrt{2}, −1/\sqrt{2}, 0), perpendicular to Z-axis. In addition, they will be aligned along Z-axis as the dashed line indicated, and their coordinates on Z-axis have the same values as their coordinates on X-axis, i.e. Z=a, b, c, respectively. Similarly, the other three originated from the positive side of X-axis, i.e. x=d, e, f, will be reflected and propagating with directional cosine (1/\sqrt{2}, −1/\sqrt{2}, 0), perpendicular to Z-axis, and aligned along Z-axis as the dashed line indicated. Their coordinates on Z-axis have the same values as their coordinates on X-axis but are all negative, i.e. Z=d −e, −f, respectively. Thus, the incoming beam representing by the six rays, or beams, has been divided into two groups of reflected beams propagating orthogonal to each other. Since the light power in each group is the function of incoming beam position on X-axis, this is obviously a beam power equalizer. It is also obvious that, as a beam power equalizer, the beam width at the reflector can be wider than the half of the reflector opening q.

Moreover, the embodiment of this invention can also be a beam position indicator and direction switch: when the intersect point of an incoming ray on a mirror of the 45° roof reflector is moving along X-axis, the reflected ray is moving along Z-axis, which makes the 45° roof reflector switched a position transformer. However, in case that the intersect point of an incoming ray totally moves from one mirror to other mirror, the reflected beam switch from one direction to other direction and the two directions are orthogonal to each other. The 45° roof reflector, in this case, functions as a switch. Similarly, if there is incoming ray array, or beam array, the 45° roof reflector functions as Mx2 switch where M is the number of rays in the ray array, or the number of the beams in the beam array.

The light beam in this patent can be either non-coherent or coherent such as beam from lasers including diode laser; it can be a wide beam or as narrow as a ray. The beam in this patent can be either collimated or non-collimated. The beams in a beam array can be either identical or different, i.e. the beam width and spacing between beams vary from beam to beam. For beam array with non-identical beams, the corresponding roof reflectors in the roof reflector array are non-identical, too, and each individual roof reflector has one-to-one accordance to the beam. However, the one-to-one correspondence between roof reflectors and emitters is not necessary; the total number of roofs in the roof reflector array can be set based the desired R and the total width of the beam array and divergence angles. The two adjacent roof reflectors can touch to each other (FIG. 5 and FIG. 10), no flat strip in between (FIG. 4) depending on the need for reflection from the flat strip.

Given the detailed description on the functions of this patent, any obvious modifications with no essential difference from the principle of this patent will constitute violation of patent rights.

What is claimed is:

1. An optical apparatus for reforming beams in a beam array, said apparatus comprising:
a plurality of light beams arranged to form a periodic light beam array, said light beam array defining a lateral direction (parallel to X-direction) along an array axis passing through a line of beams on said light beam array, a transverse direction (parallel to Y-direction) perpendicular to lateral direction and beam propagating direction (parallel to Z-direction), each of said light beam in said array being identical and characterized by dₛ, lateral dimension, d_{f}, transverse dimensions, θₛ, lateral divergence angle, and θ_{f}, transverse divergence angle, said light beam array being characterized by N_{b}, total number of said light beams, p_{b}, said beam period along lateral direction, and w_{b}, width of said light beam which is, in general, the function of propagating distance (Z-direction); and
a plurality of roof reflectors arranged to form a periodic roof reflector array, each said roof reflector in said array being formed of two reflecting surfaces which intersect along ridge and form a dihedral angle Φ between them, each said ridge being parallel to each other and oriented at a projected angle ψ_{x-y} from y-axis in x-y plane, a projected angle ψ_{y-z} from y-axis in y-z plane, said roof reflector array being characterized by Nᵣ, total number of said roof reflectors, pᵣ period of said reflector, and wᵣ, width of said roof reflector opening, and being placed in front of said light beam array with the opening of roof reflectors towards said light beams, said roof reflectors in said roof reflector array having at least a one-to-one correspondence with said light beams in said light beam array (p_{b}=pᵣ) to intercept incoming said light beams in said light beams, rotate them by reflecting them on its two reflecting surfaces, alter their propagating direction and, hence, change the configuration of said light beam array or beam SDP ratio R.

2. The optical system of claim 1 wherein said light beams are coherent beams from lasers including diode laser emitters on diode laser bar propagating along longitudinal direction of diode laser cavity with beam properties and parameters from said diode laser emitters.

3. The optical system of claim 2 wherein the said light beams from emitters on diode laser bar is collimated.

4. The optical system of claim 1 wherein the width of said light beam in said light beam array at corresponding said roof reflector in said roof reflector array is equal to the width of the roof reflector opening wᵣ.

5. The optical system of claim 1 wherein the width of said light beam in said light beam array at corresponding said roof reflector in said roof reflector array is smaller than the width of the roof reflector wᵣ.

6. The optical system of claim 1 wherein said light beams in said light beam array are not identical in width but said light beam array is still periodic.

7. The optical system of claim 6 wherein said light beam array is not periodic.

8. The optical system of claim 1 wherein said roof reflectors in said roof reflector array are not in a one-to-one correspondence with said light beams in said light beam array but both said arrays are still periodic and reflector period pᵣ is set according to the desired beam SDP ratio R.

9. The optical system of claim 8 wherein said beams in said light beam array are not identical in width.

10. The optical system of claim 9 wherein said light beam array is not periodic.

11. The optical system of claim 8 wherein N_{b}=1 and Nᵣ>1.

12. The optical system of claim 1 wherein pᵣ>wᵣ and said roof reflector array has flat strips, which can reflect light, between two adjacent roof reflectors.

13. The optical system of claim 1 wherein ψ_{y-z} is any angle as long as said light beam array can be reflected out off said roof reflector array and further propagate.

14. The optical system of claim 13 wherein ψ_{x-y}=45° and Φ=90°.

15. The optical system of claim 13 wherein ψ_{x-y}=0° and Φ=45°.

16. The optical system of claim 15 wherein the position of said light beam array relative to said roof reflector array is adjustable along x-axis.

17. The optical system of claim 16 wherein N_{b}=1 and Nᵣ=1.
